(19) United States
(12) Patent Application Publication
(10) Pub. No.: US 2024/0300360 A1
(43) Pub. Date: Sep. 12, 2024

(54) PARKING LOT MANAGEMENT SYSTEM

(71) Applicant: HONDA MOTOR CO, LTD., Tokyo (JP)

(72) Inventors: Toru OGAKI, Tokyo (JP); Yutaka FUKAI, Tokyo (JP)

(73) Assignee: HONDA MOTOR CO, LTD., Tokyo (JP)

(21) Appl. No.: 18/589,463

(22) Filed: Feb. 28, 2024

(30) Foreign Application Priority Data
Mar. 6, 2023 (JP) 2023-033865

(51) Int. Cl. B60L 53/62; B60L 53/66; B60L 58/12

(52) U.S. Cl. CPC B60L 53/62; B60L 53/66; B60L 58/12

(57) ABSTRACT

A system includes circuitry configured to: acquire a first electric power amount that is an electric power amount of an accommodation region when controlling a temperature of a vehicle parked in the accommodation region by using an air conditioner in a parking lot; acquire an total electric power amount that is a total of electric power amounts when controlling a temperature for each vehicle by using a temperature control device of each vehicle; and set a temperature control method based on the first electric power amount and the total electric power amount. The circuitry is configured to: control a temperature by using the air conditioner in the parking lot when the first electric power amount is smaller than the total electric power amount; and control a temperature for each vehicle parked in the accommodation region when the first electric power amount is greater than the total electric power amount.

### CROSS-REFERENCE RELATED APPLICATIONS

This application is based on and claims priority under 35 USC 119 from Japanese Patent Application No. 2023-033865 filed on Mar. 6, 2023, the contents of which are incorporated herein by reference.

### TECHNICAL FIELD

The present disclosure relates to a parking lot management system that manages a parking lot.

### BACKGROUND

In recent years, researches and developments have been conducted on charging and electric power supply in a vehicle mounted with a secondary battery that contributes to energy efficiency in order to allow more people to have access to affordable, reliable, sustainable, and advanced energy.

Incidentally, in a technique related to the charging and electric power supply of the vehicle mounted with the secondary battery, measures have basically been studied for each vehicle (hereinafter, referred to as an individual vehicle) so far.

For example, when a battery is placed in a high-temperature environment, since the battery becomes high in temperature and deteriorates, there is a proposal to cool the battery by using a battery cooling mechanism of a vehicle even during parking. Further, there is also a proposal to warm a vehicle interior by using waste heat of a charger by performing charging according to a travel start time, or perform pre-air conditioning according to the travel start time such that the vehicle interior has a comfortable temperature when operation is started.

In contrast, Japanese Patent Application Laid-Open Publication No. 2021-188440 (hereinafter, referred to as Patent Literature 1) discloses that a vehicle is moved to each area zoned from a viewpoint of a temperature according to a travel plan, whereby charging and discharging performance of a vehicle having a travel schedule is ensured while preventing deterioration of a battery of the stored vehicle.

In the technique disclosed in Patent Literature 1, areas are zoned from the viewpoint of the temperature by using an air-conditioning apparatus in the parking lot, but by using the air-conditioning apparatus in the parking lot, as compared with a case where a temperature is controlled for each individual vehicle, electric power consumption may increase. Further, electric power may be consumed for moving an electric vehicle.

The present disclosure provides a parking lot management system that can optimize electric power consumption of entire equipment in a parking lot. Further, this contributes to energy efficiency.

### SUMMARY

An aspect of the present disclosure relates to a parking lot management system that charges a vehicle and manages a parking lot where the vehicle is accommodated, the parking lot management system including:

an accommodation region electric power amount acquisition circuit configured to acquire an accommodation region electric power amount that is an electric power amount of an accommodation region when controlling a temperature of a vehicle parked in the accommodation region where a plurality of vehicles are parked by using an air conditioner in the parking lot;

a total electric power amount acquisition circuit configured to acquire an individual-vehicle total electric power amount that is a total of electric power amounts when controlling a temperature for each vehicle by using a temperature control device of each vehicle; and

a temperature control method setting circuit configured to set a temperature control method based on the accommodation region electric power amount and the individual-vehicle total electric power amount, in which

the temperature control method setting circuit is configured to:

execute equipment temperature control for controlling a temperature by using an air conditioner in the parking lot when the accommodation region electric power amount is smaller than the individual-vehicle total electric power amount; and

execute individual-vehicle temperature control for controlling a temperature for each vehicle parked in the accommodation region when the accommodation region electric power amount is larger than the individual-vehicle total electric power amount.

### BRIEF DESCRIPTION OF DRAWINGS

Exemplary embodiment(s) of the present invention will be described in detail based on the following figures, wherein:

FIG. 1 is a conceptual diagram of a parking lot management system 1 according to an embodiment of the present disclosure;

FIG. 2 is a block diagram showing a functional configuration of a parking lot server 10;

FIG. 3 is a diagram illustrating an accommodation region A1 where two partition regions SP1 and SP2 are set by partition units 42;

FIG. 4 is a diagram illustrating the accommodation region A1 where a partition region SP3 is set by the partition unit 42;

FIG. 5 is a flowchart showing a determination flow of a temperature control method;

FIG. 6 is a conceptual diagram of another embodiment of the parking lot management system 1; and

FIG. 7 is a diagram showing an example of a business model that uses the parking lot management system 1.

### DESCRIPTION OF EMBODIMENTS

Hereinafter, an embodiment of a parking lot management system according to the present disclosure will be described with reference to the accompanying drawings.

A parking lot management system 1 according to the present embodiment is a system that can charge a vehicle and that manages a parking lot P where a vehicle is accommodated. Particularly, the parking lot management system 1 includes a system that controls a temperature of a vehicle parked in an accommodation region A1 of the parking lot P.

A vehicle to be managed is mainly an electric vehicle on which a motor is mounted as a drive source, and for example, a lithium ion battery is mounted as a drive battery to drive the motor. The vehicle includes a temperature control device such as a battery temperature control circuit or an HVAC that individually controls a temperature of a battery.

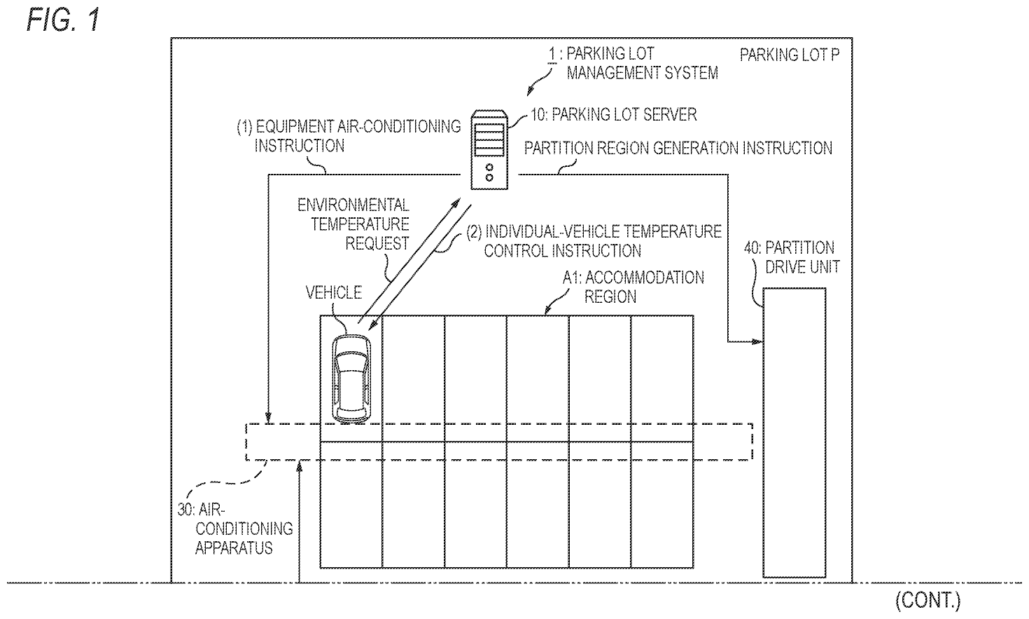

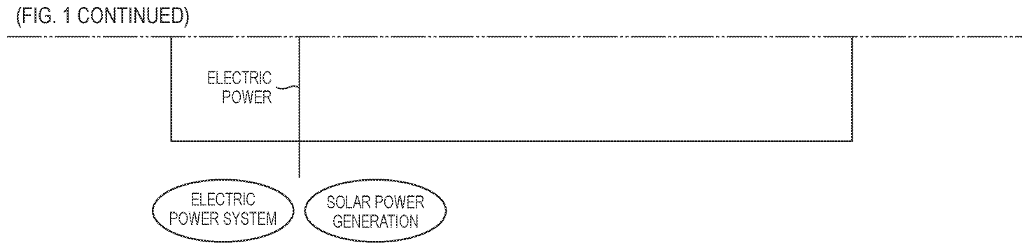

As shown in FIG. 1, the parking lot management system 1 according to the present embodiment includes a parking lot server 10, an air-conditioning apparatus 30, and a partition drive unit 40. The parking lot server 10 is an apparatus that performs main control of the parking lot management system 1, and controls the air-conditioning apparatus 30 and the partition drive unit 40. The parking lot server 10 can also communicate with a vehicle parked in the accommodation region A1 where a plurality of vehicles can be parked by wireless communication including a base station, a network, and the like. The parking lot server 10 does not need to be installed in the parking lot P. Further, a distributed server implemented by a plurality of server devices, or a distributed virtual server (cloud server) created in a cloud environment may be used.

The air-conditioning apparatus 30 is, for example, an apparatus that receives electric power by an electric power generation apparatus such as solar power generation installed in the parking lot P, an electric power system provided by an electric power company, or the like, and that air-conditions the parking lot P. The air-conditioning apparatus 30 includes a cooling device and a heating device, and controls a temperature of the parking lot P. When the parking lot P exists in a closed space such as inside a building, the air-conditioning apparatus 30 can efficiently control a temperature of the parking lot P.

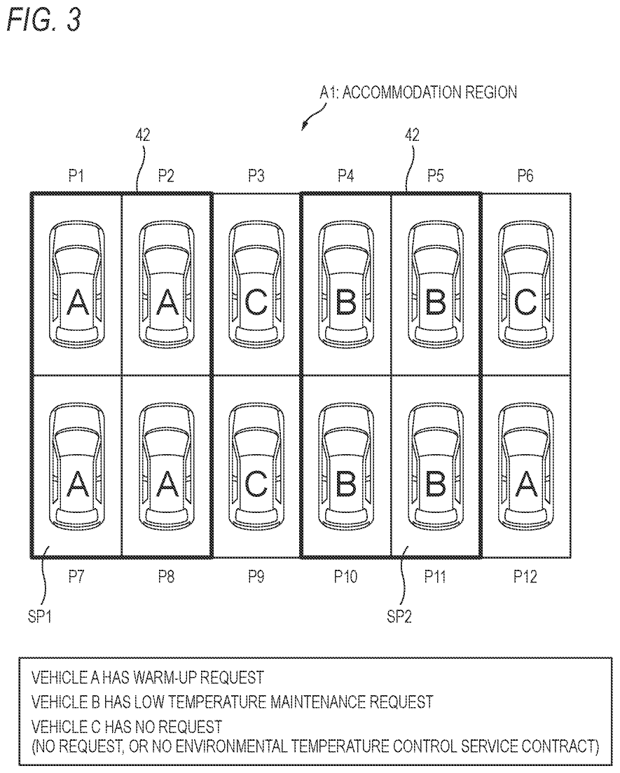

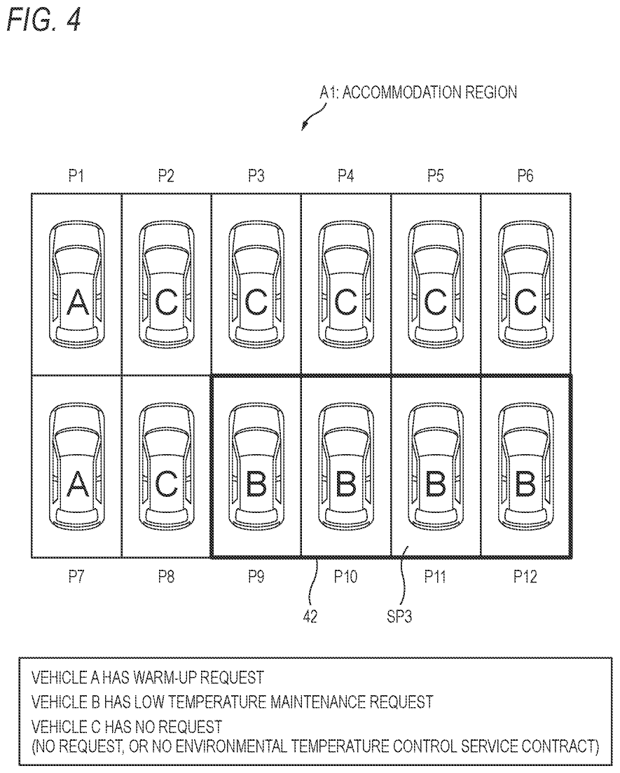

The partition drive unit 40 drives a separately provided partition unit 42 (see FIGS. 3 and 4). As will be described later, the partition unit 42 is a member that can define and form the accommodation region A1, and is implemented by, for example, a folding type partition wall accommodated in a roof of the parking lot P, a movable wall accommodated to be able to advance and retract from a side wall, a roll screen with high thermally-insulating properties, or the like. The partition drive unit 40 moves the partition unit 42 and generates partition regions SP1 to SP3 (see FIGS. 3 and 4) particularly in response to a request from a vehicle when necessary.

When controlling a temperature of a vehicle, the parking lot server 10 (parking lot management system 1) transmits, for example, the following instructions as shown in FIG. 1.

(1) An equipment air-conditioning instruction for controlling a temperature of a vehicle parked in the accommodation region A1 by using the air-conditioning apparatus 30 in the parking lot P (transmitted to the air-conditioning apparatus 30) (2) An individual-vehicle temperature control instruction for performing temperature control by using a temperature control device of each vehicle (transmitted to the vehicle)

As shown in FIG. 1, the parking lot server 10 may receive an environmental temperature request requesting environmental temperature control from each vehicle prior to the instruction (2). Further, based on the reception of the environmental temperature request, the parking lot server 10 may transmit, to the partition drive unit 40, a partition region generation instruction to drive the partition unit 42 to generate a partition region.

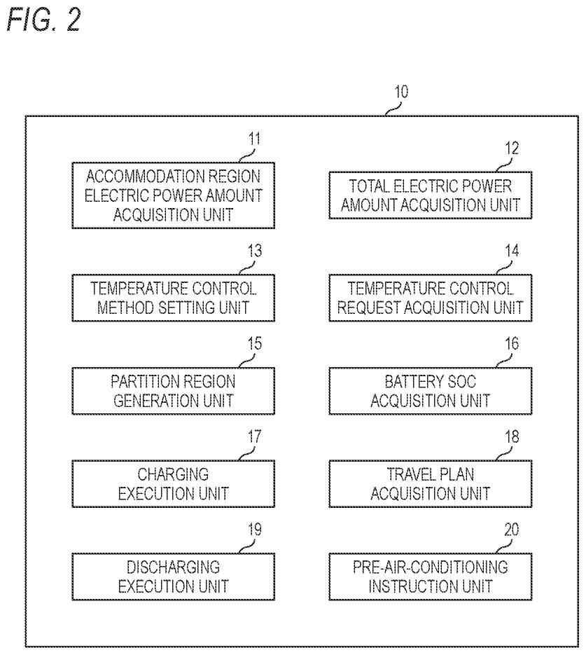

As shown in FIG. 2, the parking lot server 10 according to the present embodiment includes an accommodation region electric power amount acquisition unit 11, a total electric power amount acquisition unit 12, a temperature control method setting unit 13, a temperature control request acquisition unit 14, a partition region generation unit 15, a battery SOC acquisition unit 16, a charging execution unit 17, a travel plan acquisition unit 18, a discharging execution unit 19, and a pre-air-conditioning instruction unit 20. The parking lot server 10 is a main constituent element of the parking lot management system 1, and it can be said that the parking lot management system 1 includes these elements.

The parking lot server 10 may include a control device (computer) (not shown), and the control device may control the units described above according to a program stored in a storage unit (not shown). Each unit is software or hardware that performs a predetermined process according to an instruction of the control device.

The accommodation region electric power amount acquisition unit 11 acquires an accommodation region electric power amount that is an electric power amount of the accommodation region A1 when controlling a temperature of a vehicle parked in the accommodation region A1 by using the air-conditioning apparatus 30 in the parking lot P. The accommodation region electric power amount is an electric power consumption amount of the air-conditioning apparatus 30. The accommodation region electric power amount acquisition unit 11 can calculate the accommodation region electric power amount based on a plurality of pieces of information such as an environmental temperature, an operation prediction time, electricity expense, and past data.

The total electric power amount acquisition unit 12 acquires an individual-vehicle total electric power amount that is a total of electric power amounts when controlling a temperature for each vehicle by using the temperature control device of each vehicle. Each vehicle transmits an electric power consumption amount consumed by its own temperature control device to the parking lot server 10 by wireless communication. The total electric power amount acquisition unit 12 totals up electric power consumption of all vehicles parked in the accommodation region A1 to acquire the individual-vehicle total electric power amount.

The temperature control method setting unit 13 sets a temperature control method based on the accommodation region electric power amount acquired by the accommodation region electric power amount acquisition unit 11 and the individual-vehicle total electric power amount acquired by the total electric power amount acquisition unit 12. Specifically, the temperature control method setting unit 13 sets and executes equipment temperature control for controlling a temperature by using the air-conditioning apparatus 30 in the parking lot P (the equipment air-conditioning instruction in FIG. 1) when the accommodation region electric power amount is smaller than the individual-vehicle total electric power amount, and sets and executes individual-vehicle temperature control for controlling a temperature for each vehicle parked in the accommodation region A1 (the individual-vehicle temperature control instruction in FIG. 1) when the accommodation region electric power amount is larger than the individual-vehicle total electric power amount. That is, the temperature control method setting unit 13 selects and sets one having a smaller electric power consumption amount between the equipment air-conditioning instruction and the individual-vehicle temperature control instruction.

The temperature control request acquisition unit 14 acquires an environmental temperature control request (the environmental temperature request in FIG. 1) from a vehicle parked in the accommodation region A1. For example, the temperature control request acquisition unit 14 performs polling on a vehicle at an optional timing, and acquires the control request from the vehicle.

The partition region generation unit 15 moves the partition unit 42 (see FIGS. 3 and 4) that defines and forms the accommodation region A1 based on the control request acquired by the temperature control request acquisition unit 14. Specifically, the partition region generation unit 15 transmits the partition region generation instruction (FIG. 1) to drive the partition unit 42 to the partition drive unit 40 based on the control request. The partition drive unit 40 that receives the partition region generation instruction drives the partition unit 42 and generates the partition regions SP1 to SP3 (see FIGS. 3 and 4).

The battery SOC acquisition unit 16 acquires battery state of charge (SOC) from a vehicle parked in the accommodation region A1. The battery SOC is a value indicating a charging state of a battery of a vehicle. For example, the battery SOC acquisition unit 16 performs the polling on a vehicle at an optional timing and acquires the battery SOC from the vehicle, but may acquire the battery SOC at the same time as the temperature control request acquisition unit 14 acquires the environmental temperature control request.

The charging execution unit 17 charges a vehicle parked in the accommodation region A1. The charging execution unit 17 determines whether to perform charging based on the battery SOC acquired by the battery SOC acquisition unit 16. The charging execution unit 17 can charge a vehicle via, for example, a charging and discharging connector connected to the vehicle during parking of the vehicle. For example, when the battery SOC is smaller than a predetermined SOC threshold, and when it is predicted that the battery SOC is smaller than the SOC threshold due to the individual-vehicle temperature control, the charging execution unit 17 executes charging. The charging is not limited to the electric power transmission via the charging and discharging connector, and may be implemented by non-contact electric power transmission.

The travel plan acquisition unit 18 acquires a travel plan from a vehicle parked in the accommodation region A1. The SOC threshold described above may be, for example, a value set based on the travel plan acquired by the travel plan acquisition unit 18. The travel plan acquisition unit 18 can acquire a travel plan stored in a memory of a vehicle (car navigation system), the parking lot server 10, a portable terminal device of a user, and the like.

The discharging execution unit 19 discharges a vehicle parked in the accommodation region A1. The discharging execution unit 19 may use electric power discharged from the vehicle parked in the accommodation region A1 for the equipment temperature control, that is, temperature control of the air-conditioning apparatus 30. The discharging execution unit 19 can discharge a vehicle via, for example, the charging and discharging connector connected to the vehicle during parking of the vehicle. The discharging is not limited to the electric power transmission via the charging and discharging connector, and may be implemented by non-contact electric power transmission.

The pre-air-conditioning instruction unit 20 outputs a pre-air-conditioning instruction to execute pre-air conditioning for each vehicle parked in the accommodation region A1. The pre-air-conditioning instruction unit 20 outputs the pre-air-conditioning instruction instructing that a vehicle is to be air-conditioned appropriately in advance prior to traveling based on the travel plan acquired by the travel plan acquisition unit 18. The pre-air-conditioning instruction unit 20 can output the pre-air-conditioning instruction based on departure time and the like included in the travel plan.

FIG. 3 shows an example of the partition regions set in the accommodation region A1 according to a situation of a parked vehicle. The present example shows the accommodation region A1 where the two partition regions SP1 and SP2 are set by the partition units 42 driven by the partition drive unit 40. The partition regions SP1 and SP2 are generated by movement of the partition units 42, but actually the generation of the partition regions SP1 and SP2 performed by moving the partition units 42 is implemented when the temperature control method setting unit 13 issues the equipment air-conditioning instruction in FIG. 1.

In the example in FIG. 3, vehicles A, vehicles B, and vehicles C are vehicles that issue different environmental temperature control requests. The vehicle A is a vehicle that transmits a warm-up request as the environmental temperature control request in order to prevent a decrease in charging and discharging capacity of a battery. The vehicle B is a vehicle that transmits a low temperature maintenance request as the environmental temperature control request in order to prevent deterioration of a battery. The vehicle C is a vehicle without the environmental temperature control request. The vehicle C includes a vehicle that does not transmit the environmental temperature control request because an environmental temperature does not pose a problem for a battery, a vehicle that does not contract an environmental temperature control service, and the like.

When the temperature control request acquisition unit 14 acquires the environmental temperature control requests from the vehicles A and the vehicles B, the total electric power amount acquisition unit 12 groups a group of the vehicles A that transmit the warm-up requests into the partition region SP1, and groups a group of the vehicles B that transmit the low temperature maintenance requests into the partition region SP2. The accommodation region electric power amount acquisition unit 11 calculates an electric power consumption amount assumed for each of the partition regions SP1 and SP2, that is, an electric power consumption amount in the partition region SP1 and an electric power consumption amount in the partition region SP2. Further, when a temperature is controlled for each vehicle by using the temperature control device of each vehicle, the total electric power amount acquisition unit 12 calculates the assumed individual-vehicle total electric power amount that is a total of electric power consumption amounts of the vehicles parked in the partition region SP1 and the assumed individual-vehicle total electric power amount that is a total of electric power consumption amounts of the vehicles parked in the partition region SP2.

When the accommodation region electric power amount acquired by the accommodation region electric power amount acquisition unit 11 is larger than the individual-vehicle total electric power amount acquired by the total electric power amount acquisition unit 12, the temperature control method setting unit 13 sets and executes the individual-vehicle temperature control for controlling a temperature for each vehicle for each of the partition regions SP1 and SP2. In this case, the partition region generation unit 15 transmits the partition region generation instruction to move the partition units 42 to the partition drive unit 40. The partition drive unit 40 drives the partition units 42 and forms the partition regions SP1 and SP2 in FIG. 3.

The vehicle A is parked in a parking space P12, but there is no vehicle that issues the same kind of control request around, and it is not efficient to generate a partition region that surrounds only the vehicle to perform the equipment temperature control. Therefore, the individual-vehicle temperature control is executed without executing the equipment temperature control of the parking space P12.

The same as FIG. 3, FIG. 4 also shows an example of a partition region set in the accommodation region A1 according to a situation of a parked vehicle. The present example shows the accommodation region A1 where one partition region SP3 that partitions a group of the vehicles B that transmit the low temperature maintenance requests is set by the partition unit 42 driven by the partition drive unit 40. Actually, the process of setting the partition region SP3 is the same as that in FIG. 3. The two vehicles A are parked in parking spaces P1 and P7, but there is no vehicle that issues the same kind of control request around, and it is not efficient to generate a partition region that surrounds only the two vehicles to perform the equipment temperature control. Therefore, the individual-vehicle temperature control is executed without executing the equipment temperature control of the parking spaces P1 and P7.

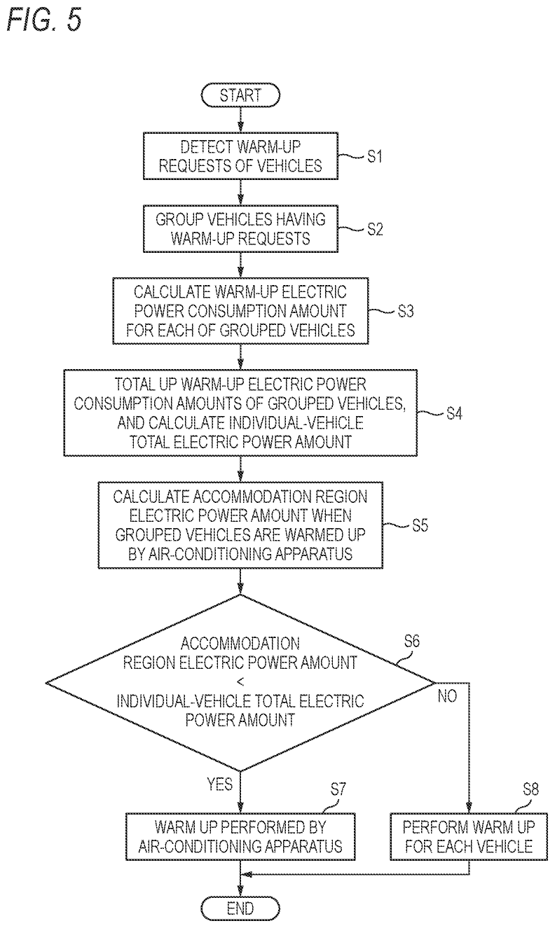

As shown in FIG. 5, the parking lot server 10 determines a temperature control method according to a situation of a vehicle parked in the accommodation region A1. In a flow in this drawing, the environmental temperature control request from a vehicle is an example of the warm-up request, but the control request may be the low temperature maintenance request.

First, the temperature control request acquisition unit 14 acquires the warm-up requests as the environmental temperature control requests from vehicles (step S1). Next, the total electric power amount acquisition unit 12 groups the vehicles that issue the warm-up requests according to a partition region (step S2), and calculates a warm-up electric power consumption amount for each of the grouped vehicles (step S3). Further, the total electric power amount acquisition unit 12 totals up the warm-up electric power consumption amounts of the grouped vehicles, and calculates a total warm-up electric power consumption amount, that is, the individual-vehicle total electric power amount (step S4).

On the other hand, the accommodation region electric power amount acquisition unit 11 calculates the warm-up electric power consumption amounts when the grouped vehicles among the vehicles parked in the accommodation region A1 are warmed up by the air-conditioning apparatus 30 in the parking lot P, that is, the accommodation region electric power amount of the accommodation region A1 (step S5).

Next, the temperature control method setting unit 13 compares the accommodation region electric power amount in step S5 with the individual-vehicle total electric power amount in step S4 (step S6), and sets and executes warm up performed by the air-conditioning apparatus 30 (step S7) when the accommodation region electric power amount is smaller than the individual-vehicle total electric power amount (accommodation region electric power amount<individual-vehicle total electric power amount) (step S6; Yes). On the other hand, the temperature control method setting unit 13 sets and executes warm up for each vehicle (step S8) when the accommodation region electric power amount in step S5 is equal to or larger than the individual-vehicle total electric power amount in step S4 (accommodation region electric power amount≥individual-vehicle total electric power amount, however, including a case where the accommodation region electric power amount is larger than the individual-vehicle total electric power amount) (step S6; No).

As described above, in the parking lot management system 1 (parking lot server 10) according to the present embodiment, the temperature control method setting unit 13 sets a temperature control method based on the accommodation region electric power amount and the individual-vehicle total electric power amount (step S6 in FIG. 5). Specifically, the temperature control method setting unit 13 executes the equipment temperature control for controlling a temperature by using the air-conditioning apparatus 30 in the parking lot P (step S7 in FIG. 5) when the accommodation region electric power amount is smaller than the individual-vehicle total electric power amount, and executes the individual-vehicle temperature control for controlling a temperature for each vehicle parked in the accommodation region A1 (step S7 in FIG. 5) when the accommodation region electric power amount is larger than the individual-vehicle total electric power amount.

Accordingly, when a plurality of vehicles parked in the parking lot P are managed as a group, electric power consumption of the entire equipment in the parking lot P can be optimized. That is, when it is preferable to control a temperature for each individual vehicle, the temperature is controlled for each individual vehicle, and when it is preferable to control a temperature by equipment air conditioning, the equipment temperature control is used, whereby the electric power consumption of the entire equipment can be reduced.

The temperature control request acquisition unit 14 acquires the environmental temperature control request (step S1 in FIG. 5). The partition region generation unit 15 moves the partition unit 42 that defines and forms the accommodation region A1 to generate the partition regions SP1 to SP3 based on the control request acquired by the temperature control request acquisition unit 14.

Accordingly, as compared with a case where a temperature of the entire accommodation region A1 is controlled, the electric power consumption of the equipment temperature control can be reduced by generating the partition regions SP1 to SP3 in the accommodation region A1 to control a temperature.

Specifically, the accommodation region electric power amount acquisition unit 11 acquires the accommodation region electric power amount of each of the partition regions SP1 to SP3 defined and formed by the partition unit 42 (step S5 in FIG. 5). The total electric power amount acquisition unit 12 acquires the individual-vehicle total electric power amount that is a total of the electric power amounts of the vehicles having the control requests among the vehicles existing in the partition regions SP1 to SP3 (step S4 in FIG. 5).

Accordingly, the accommodation region electric power amount of the partition regions SP1 to SP3 and the individual-vehicle total electric power amount that is a total of the electric power amounts of the vehicles having the control requests among the vehicles existing in the partition regions SP1 to SP3 are compared with each other, whereby the electric power consumption of the entire equipment can be further reduced.

As shown in FIGS. 3 and 4, the partition region generation unit 15 preferably generates the partition regions SP1 to SP3 so as to only surround the vehicles having the control requests. Accordingly, since it is not necessary to warm up vehicles without the control requests by the equipment temperature control, it is possible to only efficiently warm up the vehicles having the control requests.

As described above, the parking lot management system 1 according to the present embodiment also includes the battery SOC acquisition unit 16 and the charging execution unit 17. The charging execution unit 17 can determine whether to perform charging based on the battery SOC acquired by the battery SOC acquisition unit 16.

Accordingly, since necessary charging is performed only by keeping a vehicle in the parking lot P, convenience of the parking lot P is improved.

When the battery SOC is smaller than the SOC threshold, and when it is predicted that the battery SOC is smaller than the SOC threshold due to the individual-vehicle temperature control, the charging execution unit 17 can execute charging.

Accordingly, since the charging is managed in consideration of a decrease in the battery SOC in a case of the individual-vehicle temperature control, convenience of the parking lot P is further improved.

As described above, the parking lot management system 1 according to the present embodiment also includes the travel plan acquisition unit 18 that acquires a travel plan from a vehicle parked in the accommodation region A1. The SOC threshold described above can be set based on the travel plan acquired by the travel plan acquisition unit 18.

Accordingly, since charging is performed based on the travel plan of the user, chances of performing charging during traveling can be reduced, and convenience of the parking lot P is further improved.

In the parking lot P, the equipment temperature control or charging of the vehicle can be performed by using renewable energy such as solar power generation. Accordingly, natural energy can be effectively used.

As described above, the parking lot management system 1 according to the present embodiment also includes the discharging execution unit 19, can discharge a vehicle parked in the accommodation region A1, and can use electric power discharged from the vehicle parked in the accommodation region A1 for the equipment temperature control, that is, temperature control performed by the air-conditioning apparatus 30. Accordingly, the electric power consumption of the entire equipment in the parking lot P can be optimized.

The discharging execution unit 19 can supply the electric power discharged from the vehicle parked in the accommodation region A1 to an electric power system. Accordingly, the parking lot P can function as a virtual electric power plant (VPP).

Further, the discharging execution unit 19 can determine whether to perform discharging based on a smart grid cooperation contract with an owner of a vehicle.

Accordingly, whether to discharge electric power to the electric power system based on the smart grid cooperation contract is determined, whereby an intention of the user can be reflected.

As described above, the parking lot management system 1 according to the present embodiment also includes the pre-air-conditioning instruction unit 20 that outputs the pre-air-conditioning instruction to execute pre-air conditioning for each vehicle parked in the accommodation region A1. The pre-air-conditioning instruction unit 20 can output the pre-air-conditioning instruction based on the travel plan acquired by the travel plan acquisition unit 18.

Accordingly, the pre-air conditioning is managed by the parking lot management system 1, whereby convenience of the parking lot P is improved.

The pre-air-conditioning instruction unit 20 can determine whether to perform pre-air conditioning based on a pre-air-conditioning service contract with the owner of the vehicle. Accordingly, by determining whether to discharge electric power to the electric power system based on the pre-air-conditioning service contract, an intention of the user can be reflected.

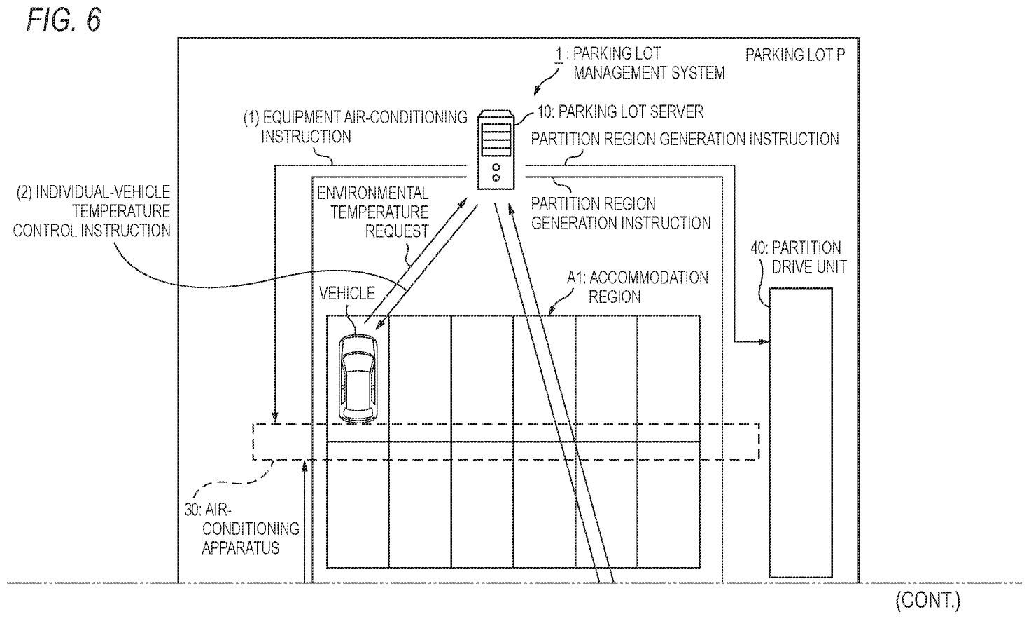

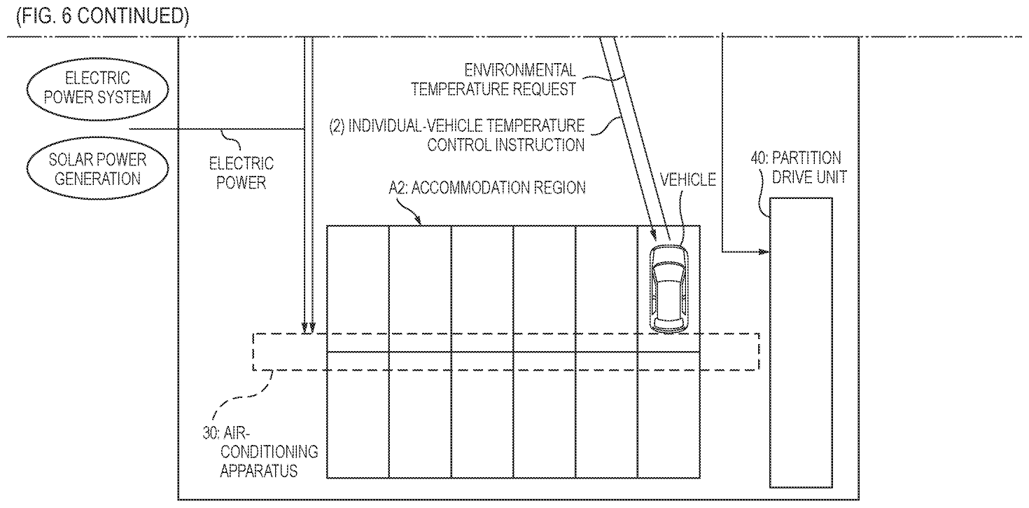

As shown in FIG. 6, the parking lot management system 1 according to another embodiment can manage the parking lot P including two accommodation regions A1 and A2. The parking lot management system 1 can also manage a larger parking lot P. The number of accommodation regions may be three or more or one.

When the parking lot P includes a plurality of accommodation regions A1 and A2 as described above, the accommodation region electric power amount acquisition unit 11 and the temperature control method setting unit 13 can manage a temperature control method for each of the accommodation regions A1 and A2. Accordingly, the temperature control equipment can be optimized, and management can be made easy.

The plurality of accommodation regions may exist on one floor, or may exist across a plurality of floors. The parking lot P where the plurality of accommodation regions exist across the plurality of floors is a so-called multi-level parking lot where at least one accommodation region exists on each hierarchy.

Accordingly, a space can be effectively used by making the parking lot P into the multi-level parking lot, and management becoming complicated can be avoided by performing management such that one accommodation region does not exist across a plurality of floors.

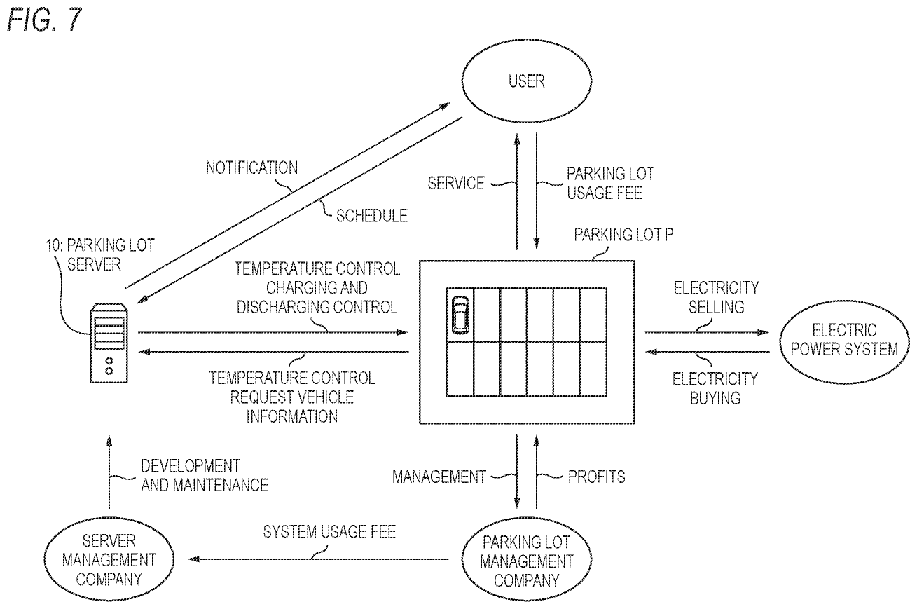

As shown in FIG. 7, the parking lot management system 1 is used, whereby a series of business models related to an electric vehicle are provided. The user pays parking lot usage fee to a parking lot management company, and the parking lot management company manages the parking lot P in return while earning profits, and provides a service to the user.

In the present example, the parking lot management company pays a system usage fee to a server management company, and entrusts management of the parking lot server 10. The server management company develops and maintains the parking lot server 10. Accordingly, the parking lot server 10 performs the temperature control of the parking lot P by receiving the temperature control request from a vehicle, and performs the charging and discharging control by receiving the vehicle information such as the battery SOC from the vehicle as described above.

The user can transmit a schedule based on the travel plan to the parking lot server 10 by using an electronic terminal such as a smartphone. The parking lot server 10 issues a notification according to the schedule to the user, whereby convenience of the user increases.

The parking lot P can buy electric power from an electric power system such as an electric power company (electricity buying) to operate the equipment, and can sell electric power obtained from solar power generation, vehicle discharging, and the like to the electric power company (electricity selling). Through such a series of flows, parties can obtain a service and profits.

As described above, an aspect for carrying out the present disclosure has been described using the embodiment, but the present disclosure is by no means limited to such an embodiment, and various modifications and replacements can be made without departing from the gist of the present disclosure.

In the present specification, at least the following matters are described. Corresponding constituent elements and the like in the embodiments described above are shown in parentheses, but the present disclosure is not limited thereto.

(1) A parking lot management system (the parking lot management system 1) that charges a vehicle and manages a parking lot (the parking lot P) where the vehicle is accommodated, the parking lot management system including:

an accommodation region electric power amount acquisition circuit (the accommodation region electric power amount acquisition unit 11) configured to acquire an accommodation region electric power amount that is an electric power amount of an accommodation region when controlling a temperature of a vehicle parked in the accommodation region (the accommodation region A1) where a plurality of vehicles are parked by using an air conditioner in the parking lot;

a total electric power amount acquisition circuit (the total electric power amount acquisition unit 12) configured to acquire an individual-vehicle total electric power amount that is a total of electric power amounts when controlling a temperature for each vehicle by using a temperature control device of each vehicle; and

a temperature control method setting circuit (the temperature control method setting unit 13) configured to set a temperature control method based on the accommodation region electric power amount and the individual-vehicle total electric power amount, in which

the temperature control method setting circuit is configured to:

execute equipment temperature control for controlling a temperature by using the air conditioner in the parking lot when the accommodation region electric power amount is smaller than the individual-vehicle total electric power amount; and

execute individual-vehicle temperature control for controlling a temperature for each vehicle parked in the accommodation region when the accommodation region electric power amount is greater than the individual-vehicle total electric power amount.

According to (1), when the plurality of vehicles parked in the parking lot are managed as a group, electric power consumption of the entire equipment in the parking lot can be optimized. That is, when it is preferable to control a temperature for each individual vehicle, the temperature is controlled for each individual vehicle, and when it is preferable to control a temperature by equipment air conditioning, the equipment temperature control is used, whereby the electric power consumption of the entire equipment can be reduced.

(2) The parking lot management system according to (1), further including:

a temperature control request acquisition circuit (the temperature control request acquisition unit 14) configured to acquire a request for controlling an environmental temperature from a vehicle parked in the accommodation region; and

a partition region generation circuit (the partition region generation unit 15) configured to move a partition (the partition unit 42) for defining and forming the accommodation region to generate a partition region (the partition regions SP1 to SP3) based on the request.

According to (2), as compared with a case where a temperature of the entire accommodation region is controlled, electric power consumption of the equipment temperature control can be reduced, and electric power consumption of the entire equipment can be further reduced by generating the partition region in the accommodation region to control a temperature.

(3) The parking lot management system according to (2), in which

the accommodation region electric power amount acquisition circuit acquires an accommodation region electric power amount of a partition region defined and formed by the partition, and

the total electric power amount acquisition circuit acquires an individual-vehicle total electric power amount that is a total of electric power amounts of vehicles having the control requests among vehicles existing in the partition region.

According to (3), the accommodation region electric power amount of the partition region and the individual-vehicle total electric power amount that is a total of the electric power amounts of the vehicles having the control requests among the vehicles existing in the partition region are compared with each other, whereby more accurate comparison can be performed, and the electric power consumption of the entire equipment can be reduced.

(4) The parking lot management system according to (3), in which

the partition region generation circuit generates the partition region so as to surround only a vehicle having the request.

According to (4), since it is not necessary to warm up a vehicle without the control request by the equipment temperature control, it is possible to only efficiently warm up the vehicle having the control request.

(5) The parking lot management system according to (1), further including:

a battery SOC acquisition circuit (the battery SOC acquisition unit 16) configured to acquire a battery SOC from a vehicle parked in the accommodation region; and

a charging execution circuit (the charging execution unit 17) configured to charge a vehicle parked in the accommodation region, in which

the charging execution circuit determines whether to perform charging based on the battery SOC.

According to (5), since necessary charging is performed only by keeping a vehicle in the parking lot, convenience of the parking lot is improved.

(6) The parking lot management system according to (5), in which

when the battery SOC is smaller than a SOC threshold, and when it is predicted that the battery SOC is smaller than the SOC threshold due to the individual-vehicle temperature control, the charging execution circuit performs the charging.

According to (6), since the charging is managed in consideration of a decrease in the battery SOC in a case of the individual-vehicle temperature control, convenience of the parking lot is further improved.

(7) The parking lot management system according to (6), further including:

a travel plan acquisition circuit (the travel plan acquisition unit 18) configured to acquire a travel plan from a vehicle parked in the accommodation region, in which

the SOC threshold is set based on the travel plan.

According to (7), since charging is performed based on the travel plan of a user, chances of performing charging during traveling can be reduced, and convenience of the parking lot is further improved.

(8) The parking lot management system according to any one of (1) to (7), in which

in the parking lot, the equipment temperature control or charging of the vehicle is performed using renewable energy.

According to (8), natural energy can be effectively used.

(9) The parking lot management system according to any one of (1) to (7), further including:

a discharging execution circuit (the discharging execution unit 19) configured to discharge a vehicle parked in the accommodation region, in which

the discharging execution circuit uses electric power discharged from the vehicle parked in the accommodation region for the equipment temperature control.

According to (9), electric power consumption of the entire equipment in the parking lot can be optimized.

(10) The parking lot management system according to any one of (1) to (7), further including:

a discharging execution circuit (the discharging execution unit 19) configured to discharge a vehicle parked in the accommodation region, in which

the discharging execution circuit supplies electric power discharged from the vehicle parked in the accommodation region to an electric power system.

According to (10), the parking lot can function as a virtual electric power plant (VPP).

(11) The parking lot management system according to (10), in which

the discharging execution circuit determines whether to perform the discharging based on a smart grid cooperation contract with an owner of the vehicle.

According to (11), whether to discharge electric power to the electric power system based on the smart grid cooperation contract is determined, whereby an intention of the user can be reflected.

(12) The parking lot management system according to any one of (1) to (7), further including:

a travel plan acquisition circuit (the travel plan acquisition unit 18) configured to acquire a travel plan from a vehicle parked in the accommodation region; and

a pre-air-conditioning instruction circuit (the pre-air-conditioning instruction unit 20) configured to output a pre-air-conditioning instruction to execute pre-air conditioning for each vehicle parked in the accommodation region, in which

the pre-air-conditioning instruction circuit outputs the pre-air-conditioning instruction based on the travel plan.

According to (12), the pre-air conditioning is managed by the parking lot management system, whereby convenience of the parking lot is improved.

(13) The parking lot management system according to (12), in which

the pre-air-conditioning instruction circuit determines whether to perform the pre-air conditioning based on a pre-air-conditioning service contract with an owner of the vehicle.

According to (13), by determining whether to discharge electric power to the electric power system based on the pre-air-conditioning service contract, an intention of the user can be reflected.

(14) The parking lot management system according to (1), in which

the parking lot includes a plurality of accommodation regions (the accommodation regions A1 and A2), and

the accommodation region electric power amount acquisition circuit and the temperature control method setting circuit manage a temperature control method for each of the accommodation regions.

According to (14), the temperature control equipment can be optimized, and management can be made easy.

(15) The parking lot management system according to (14), in which

the parking lot is a multi-level parking lot, and

at least one accommodation region exists on each hierarchy.

According to (15), a space can be effectively used by using the multi-level parking lot, and management becoming complicated can be avoided by performing management such that one accommodation region does not exist across a plurality of floors.

1. A parking lot management system that charges a vehicle and manages a parking lot where the vehicle is accommodated, the parking lot management system comprising:
an accommodation region electric power amount acquisition circuit configured to acquire an accommodation region electric power amount that is an electric power amount of an accommodation region when controlling a temperature of a vehicle parked in the accommodation region where a plurality of vehicles are parked by using an air conditioner in the parking lot;
a total electric power amount acquisition circuit configured to acquire an individual-vehicle total electric power amount that is a total of electric power amounts when controlling a temperature for each vehicle by using a temperature control device of each vehicle; and
a temperature control method setting circuit configured to set a temperature control method based on the accommodation region electric power amount and the individual-vehicle total electric power amount, wherein
the temperature control method setting circuit is configured to:
execute equipment temperature control for controlling a temperature by using the air conditioner in the parking lot when the accommodation region electric power amount is smaller than the individual-vehicle total electric power amount; and
execute individual-vehicle temperature control for controlling a temperature for each vehicle parked in the accommodation region when the accommodation region electric power amount is greater than the individual-vehicle total electric power amount.

2. The parking lot management system according to claim 1, further comprising:
a temperature control request acquisition circuit configured to acquire a request for controlling an environmental temperature from a vehicle parked in the accommodation region; and
a partition region generation circuit configured to move a partition for defining and forming the accommodation region to generate a partition region based on the request.

3. The parking lot management system according to claim 2, wherein
the accommodation region electric power amount acquisition circuit acquires an accommodation region electric power amount of a partition region defined and formed by the partition, and
the total electric power amount acquisition circuit acquires an individual-vehicle total electric power amount that is a total of electric power amounts of vehicles having the request among vehicles in the partition region.

4. The parking lot management system according to claim 3, wherein
the partition region generation circuit generates the partition region so as to surround only a vehicle having the request.

5. The parking lot management system according to claim 1, further comprising:
a battery SOC acquisition circuit configured to acquire a battery SOC from a vehicle parked in the accommodation region; and
a charging execution circuit configured to charge a vehicle parked in the accommodation region, wherein
the charging execution circuit determines whether to perform charging based on the battery SOC.

6. The parking lot management system according to claim 5, wherein
when the battery SOC is smaller than a SOC threshold, and when it is predicted that the battery SOC is smaller than the SOC threshold due to the individual-vehicle temperature control, the charging execution circuit performs the charging.

7. The parking lot management system according to claim 6, further comprising:
a travel plan acquisition circuit configured to acquire a travel plan from a vehicle parked in the accommodation region, wherein
the SOC threshold is set based on the travel plan.

8. The parking lot management system according to claim 1, wherein
in the parking lot, charging of the vehicle is performed using renewable energy.

9. The parking lot management system according to claim 1, further comprising:
a discharging execution circuit configured to discharge a vehicle parked in the accommodation region, wherein
the discharging execution circuit uses electric power discharged from the vehicle parked in the accommodation region for the equipment temperature control.

10. The parking lot management system according to claim 1, further comprising:
a discharging execution circuit configured to discharge a vehicle parked in the accommodation region, wherein
the discharging execution circuit supplies electric power discharged from the vehicle parked in the accommodation region to an electric power system.

11. The parking lot management system according to claim 10, wherein
the discharging execution circuit determines whether to perform the discharging based on a smart grid cooperation contract with an owner of the vehicle.

12. The parking lot management system according to claim 1, further comprising:
a travel plan acquisition circuit configured to acquire a travel plan from a vehicle parked in the accommodation region; and
a pre-air-conditioning instruction circuit configured to output a pre-air-conditioning instruction to execute pre-air conditioning for each vehicle parked in the accommodation region, wherein
the pre-air-conditioning instruction circuit outputs the pre-air-conditioning instruction based on the travel plan.

13. The parking lot management system according to claim 12, wherein
the pre-air-conditioning instruction circuit determines whether to perform the pre-air conditioning based on a pre-air-conditioning service contract with an owner of the vehicle.

14. The parking lot management system according to claim 1, wherein
the parking lot includes a plurality of accommodation regions, and
the accommodation region electric power amount acquisition circuit and the temperature control method setting circuit manage a temperature control method for each of the accommodation regions.

15. The parking lot management system according to claim 14, wherein
the parking lot is a multi-level parking lot, and
at least one accommodation region exists on each hierarchy.
